(19) United States
(12) Patent Application Publication
(10) Pub. No.: US 2021/0360749 A1
(43) Pub. Date: Nov. 18, 2021

(54) IMAGE ACQUISITION ARRANGEMENT OF A MOTOR VEHICLE

(71) Applicant: K.L. KASCHIER- UND LAMINIER GMBH, BAD BENTHEIM-GILDEHAUS (DE)

(72) Inventor: REMBERT SCHULZE WEHNINCK, TUTZING (DE)

(73) Assignee: K.L. KASCHIER- UND LAMINIER GMBH, BAD BENTHEIM-GILDEHAUS (DE)

(21) Appl. No.: 17/242,319

(22) Filed: Apr. 28, 2021

(30) Foreign Application Priority Data
May 15, 2020 (DE) 10 2020 113 199.2

(51) Int. Cl. H05B 3/84; B60R 11/04

(52) U.S. Cl. CPC H05B 3/84; B60R 11/04

(57) ABSTRACT

An arrangement for capturing an image of a space in front of or behind a motor vehicle, the motor vehicle having a motor vehicle windowpane which has an inner surface. The arrangement includes an image acquisition unit and a transparent heating film. The image acquisition unit is mounted on an inside of the motor vehicle windowpane. The image acquisition unit has a field of vision. The transparent heating film is arranged in the field of vision of the image acquisition unit and is attached to the inner surface of the motor vehicle windowpane.

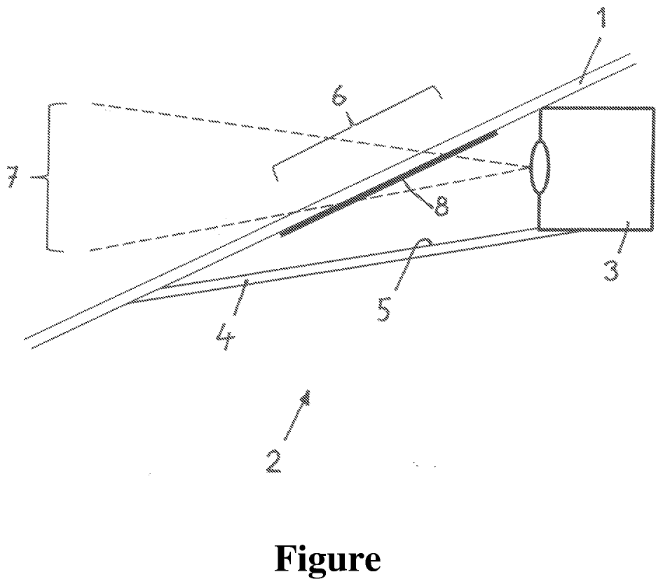

### CROSS REFERENCE TO PRIOR APPLICATIONS

Priority is claimed to German Patent Application No. DE 10 2020 113 199.2, filed May 15, 2020. The entire disclosure of said application is incorporated by reference herein.

### FIELD

The present invention relates to an arrangement for capturing an image of the space in front of or behind a motor vehicle with an image acquisition unit which is mounted on the inside of a motor vehicle windowpane.

### BACKGROUND

An image acquisition arrangement for a motor vehicle is described in DE 10 2014 006 891 A1. A lens shade with a heating element is arranged below the field of vision of the image acquisition unit in order to keep the inside of the motor vehicle windowpane free of fogging, icing, and to prevent the formation of hoar frost. The construction of such a lens shade is technically complex.

The field of vision of the image acquisition unit may alternatively be kept free of icing and fogging by providing heating elements, in particular in the form of silver printing, in the windowpane around the field of vision. A disadvantage of this arrangement is that much time is needed until the middle of the field of vision is free of ice. A subsequent electric contacting, for example, by way of soldering, is furthermore time consuming and costly.

Another previously described alternative is to incorporate heating media, in particular wires, in the windowpane within the field of vision of the image acquisition apparatus itself. A disadvantage thereof is interference with the field of vision of the camera and that a subsequent electric contacting, for example, by way of soldering, is time consuming and costly.

### SUMMARY

An aspect of the present invention is to provide an image acquisition arrangement of the kind mentioned above in which the lens shade has a simple technical construction without a heating device.

In an embodiment, the present invention provides an arrangement for capturing an image of a space in front of or behind a motor vehicle, the motor vehicle comprising a motor vehicle windowpane which comprises an inner surface. The arrangement includes an image acquisition unit and a transparent heating film. The image acquisition unit is mounted on an inside of the motor vehicle windowpane. The image acquisition unit comprises a field of vision. The transparent heating film is arranged in the field of vision of the image acquisition unit and is attached to the inner surface of the motor vehicle windowpane.

### BRIEF DESCRIPTION OF THE DRAWINGS

The present invention is described in greater detail below on the basis of embodiments and of the drawing in which:

The FIGURE shows an embodiment of the image acquisition arrangement having a heating film of the present invention.

### DETAILED DESCRIPTION

The present invention provides that a transparent heating film is attached on the inner surface of the motor vehicle windowpane, the transparent heating film being located in the field of vision of the image acquisition unit.

Such an arrangement for the image acquisition comprises a lens shade having a technically simple construction because it is not used for heating. The motor vehicle windowpane is heated exactly in that area where it tends to fog or ice up so that no heating of other areas of the image acquisition arrangement occurs. Energy is thereby saved.

A simple and safe attachment is achieved when the heating film is attached to the inner surface of the motor vehicle windowpane with a likewise transparent adhesive.

An embodiment of the present invention is shown schematically in the drawing which is described in greater detail below.

The FIGURE shows that an image acquisition arrangement 2 comprising an image acquisition unit 3 is attached on the inner surface or back of a motor vehicle window pane 1, in particular a windshield or a rear window pane. The image acquisition arrangement 2 is closed on its bottom side by a covering 4 which forms a lens shade 5 on its upper side.

The motor vehicle windowpane 1 has a see-through area 6 through which the field of vision 7 of the image acquisition unit 3 extends. The motor vehicle window pane 1 is covered on its inside in the area of the see-through area 6 by a radiolucent, transparent heating film 8, the heating of which safely prevents fogging, icing and/or the formation of hoar frost on the motor vehicle window pane 1.

The heating film 8 is attached to the inner surface of the motor vehicle windowpane 1 via a full surface application of a transparent adhesive.

The present invention is not limited to embodiments described herein; reference should be had to the appended claims.

### LIST OF REFERENCE NUMERALS

1 Motor vehicle windowpane

2 Image acquisition arrangement

3 Image acquisition unit

4 Covering

5 Lens shade

6 See-through area

7 Field of vision

8 Heating film

What is claimed is:

1. An arrangement for capturing an image of a space in front of or behind a motor vehicle, the motor vehicle comprising a motor vehicle windowpane which comprises an inner surface, the arrangement comprising:
an image acquisition unit which is mounted on an inside of the motor vehicle windowpane, the image acquisition unit comprising a field of vision; and
a transparent heating film which is arranged in the field of vision of the image acquisition unit and which is attached to the inner surface of the motor vehicle windowpane.

2. The arrangement as recited in claim 1, wherein the transparent heating film is attached to the inner surface of the motor vehicle window pane via a transparent adhesive.

3. The arrangement as recited in claim 1, wherein the transparent heating film comprises a substrate film on which heating conductors are arranged.
